(19) United States
(12) Patent Application Publication
(10) Pub. No.: US 2014/0072810 A1
(43) Pub. Date: Mar. 13, 2014

(54) Method for Producing a Sol-Gel Coating on Surfaces with Vitreous Ceramic Enamels and Coating Thus Produced

(71) Applicants: Fernando Gonzalez-Juarez, Barcelona (ES); Antonio Jorge De Alburquerque Sanchez, Barcelona (ES); Jordi Balcells Villanueva, Barcelona (ES); Alberto Quintana Bartual, Barcelona (ES); Jose Francisco Fernandez Lozano, Madrid (ES); Esther Enriquez Perez, Madrid (ES); Miguel Angel De La Rubia Lopez, Madrid (ES); Miguel Angel Garcia Garcia-Tunon, Madrid (ES); Miguel Angel Rodriguez Barbero, Madrid (ES)

(72) Inventors: Fernando Gonzalez-Juarez, Barcelona (ES); Antonio Jorge De Alburquerque Sanchez, Barcelona (ES); Jordi Balcells Villanueva, Barcelona (ES); Alberto Quintana Bartual, Barcelona (ES); Jose Francisco Fernandez Lozano, Madrid (ES); Esther Enriquez Perez, Madrid (ES); Miguel Angel De La Rubia Lopez, Madrid (ES); Miguel Angel Garcia Garcia-Tunon, Madrid (ES); Miguel Angel Rodriguez Barbero, Madrid (ES)

(73) Assignee: Roca Sanitario, S.A., Barcelona (ES)

(21) Appl. No.: 14/000,984

(22) PCT Filed: Feb. 21, 2012
(86) PCT No.: PCT/ES2012/070095

§ 371 Date: Nov. 26, 2013

(30) Foreign Application Priority Data
Feb. 22, 2011 (ES) P201130230

(51) Int. Cl. C04B 41/85

(52) U.S. Cl. CPC C04B 41/85
USPC 428/426; 427/397.7

(57) ABSTRACT

The process is characterised in that it comprises at least one sol-gel layer with a maximum thickness of 800 nm, where said sol-gel layer comprises nanoparticles with a laminar crystal structure, and where each sol-gel layer is obtained from a silicon alkoxide solution; preparation of a dispersion that comprises at least one type of particles with a spherical, fibrillar or laminar morphology, and a laminar crystal structure, wherein at least one of the dimensions, thickness or diameter, of said particles is less than 400 nm; addition of the dispersion prepared to the solution; deposition of the suspension on said substrate; thermal treatment of the substrate; and, in the case of multilayer coatings, optionally, the addition of high-dimensional particles and repetition of the steps, provided that the thermal treatment of the last layer, or outer layer, is performed at a temperature equal to or greater than that of the preceding layer. The invention also relates to the sol-gel coating thus obtained.

The present invention solves the problem of contraction in the densification of high-thickness sol-gel coatings and, moreover, provides a process for obtaining a sol-gel coating useful for ceramic surfaces with a large size and/or complex shapes.

### FIELD OF THE INVENTION

The present invention relates to the field of coatings on vitrified ceramic enamel surfaces. In particular, it relates to coatings on sanitary porcelain enamels, sanitary stoneware, ceramic floor tiles and tiles, and steel and cast iron bathtub enamels, which are to be endowed with different active and passive functional surface properties.

The invention relates to a process for obtaining a single-layer or multilayer sol-gel coating wherein the type of particles incorporated provides a sol-gel coating with special characteristics. Moreover, the process is especially useful for obtaining a sol-gel coating on surfaces that are large-sized and have complex shapes, such as, in general, those of porcelains and other sanitary ware.

### BACKGROUND OF THE INVENTION

The general principles, processes, materials and applications of the sol-gel method are publicly known and are described in different publications and textbooks, such as, for example, the Handbook of Sol-gel Science and Technology. Processing, Characterization and Applications. Edited by Sumio Sakkad. Kluwer Academic Publisher, NY 2005.

The general sol-gel process is based on the hydrolysis of a precursor of the metal cation wherewith the coating is to be formed upon coming in contact with water, a common solvent, since the precursor is usually not soluble in water, and a catalyst which accelerates the process. The reactions that take place during this process may be divided into four steps:

1) Hydrolysis, where the metal alkoxide reacts with the water molecule, substituting an alkoxide group with a hydroxyl group;

2) Polycondensation, where a partially hydrolysed molecule reacts with another hydrolysed or non-hydrolysed molecule, releasing a water or alcohol molecule, respectively;

3) Ageing, which takes place some time after gelation and involves: polymerisation, syneresis and maturation; and

4) Thermal densification.

The versatility of this technology has led to multiple functional properties that have resulted in patents based on this type of coatings.

There are different patents based on different oxide (primarily silicon, zinc, aluminum and titanium) manufacturing methods, which are variations of the sol-gel method. There are also patents for coatings prepared using the sol-gel technique on vitreous or metallic material substrates, designed to obtain a protective surface against external agents, which include, as examples:
Sol-gel coatings as protective agents against corrosion (FR2710278).
Abrasion resistance of ceramic materials in dishwashers (U.S. Pat. No. 5,166,248) and detergent resistance (FR2904206).
Sol-gel coatings with catalytic properties (DE102004041695) (U.S. Pat. No. 5,324,544).
Sol-gel coatings designed to obtain hydrophobic surfaces (EP1526922).

Said patents include specific applications of variants of the sol-gel process which are limited to the use of one layer or several layers with a similar composition. The advantages of the protection offered by sol-gel coatings are based on the formation of a layer that acts as an interphase between the substrate to be protected and the external agent. Said protective layer presents a limited action, partly due to the appearance of defects during the shaping or cracks resulting from the coating densification processes. The presence of defects or cracks favours exposure of the substrate to external agents, primarily chemical agents, against which it is desired to protect the substrate. The loss of coating adhesion to the substrate occurs as a consequence of the corrosion thereof, which, in general, leads to failure of the coating by delamination. Furthermore, the coatings present a severe surface wear problem in the face of abrasion, which limits the implementation of said coatings.

There are a limited number of patents for producing coatings by means of the sol-gel technique for traditional ceramics and even sanitary elements, in order to obtain functional surfaces. The sol-gel process has been used to coat dishes and prevent lead leaching (JP6064941) or to obtain high-resistance transparent coatings (WO9108179). Said coatings are produced by forming compositions in the ZrO₂—SiO₂—TiO₂ system that are subjected to a thermal treatment at temperatures >450° C., considerably lower than those used in the consolidation of the ceramic product. The vitreous nature of the coating is characterised by abrasion resistance, ease of cleaning and gloss similar to those of a conventional ceramic product. This type of processes has also been applied by incorporating nanoparticles to obtain coatings obtained by the sol-gel technique, incorporating TiO₂ nanoparticles with an antibiotic effect on ceramic tiles (CN 101058510).

The nanoparticles may be formed in situ on the coating during the sol-gel process, such as, for example, a sol-gel coating incorporating antimicrobial particles obtained from silver chloride (WO200014029) or a sol-gel coating for sanitary ware containing metallic elements such as copper or noble metals (DE10253841).

The state of the art has not disclosed any sol-gel coating that solves the contraction problem that occurs in the densification step in sol-gel coatings with a thickness greater than 400 nm, wherein, at the same time, said coating confers functional properties upon sanitary ceramics and preserves the required resistance properties of said surfaces.

Another problem that has still not been resolved in the state of the art is the formation of sol-gel coatings on large-sized surfaces which, moreover, may have concave and/or convex shapes in one piece, as in the case of sanitary ceramics.

### BRIEF DESCRIPTION OF THE INVENTION

In order to solve the problems of the previous techniques, a first aspect of the invention provides a process for obtaining a high-thickness single-layer sol-gel coating on a vitrified ceramic enamel substrate that comprises the addition of nanoparticles, where said nanoparticles, also called low-dimensional particles in the invention, are characterised in that they have a laminar crystal structure and said single-layer coating has a thickness greater than 400 nm. Said coating may have a thickness of up to 800 nm.

A second aspect of the invention provides a process for obtaining a multilayer sol-gel coating on a vitrified ceramic enamel substrate that comprises obtaining a multilayer structure, with layers having a different composition and/or morphology, where at least one of said layers fulfils the requirement of the first aspect of the invention.

### DESCRIPTION OF THE FIGURES

FIG. 1 shows the problems arising from the difference in contraction in high-thickness sol-gel coatings, before and after the densification treatment. In particular, it shows a sol-gel coating recently deposited on a ceramic substrate when the thickness of said coating is less than 400 nm (1-a)) and after the densification treatment (1-b)); a sol-gel coating recently deposited on a ceramic substrate when the thickness of said coating is greater than 400 nm (1-c)) and after the densification treatment (1-d)); a sol-gel coating recently deposited on a ceramic substrate when the thickness of said coating is greater than 400 nm and has nanoparticles with a laminar crystal structure incorporated therein (1-e)) and after the densification treatment (1-f)).

FIG. 2 shows a coating on a sanitary porcelain support (2) obtained by the sol-gel technique (1), where said coating comprises nanoparticles with a laminar crystal structure and the following different morphologies: spherical (3), fibrillar (4) or laminar (5).

FIG. 3 shows a multilayer coating on a sanitary porcelain support (2) obtained by the sol-gel technique. The coating contains low-dimensional particles with a laminar crystal structure and a laminar morphology (5) in the first layer (10). The second (11), third (12) and fourth layers (13) contain low-dimensional particles with a spherical morphology (3). The fifth layer, or outer layer (14), contains, in addition to the low-dimensional particles with a spherical morphology (3), low-dimensional particles with a fibrillar morphology (4).

FIG. 4 shows a multilayer coating on a sanitary porcelain support (2) obtained by the sol-gel technique. The coating is composed of four layers (15-18) which contain low-dimensional particles with a laminar crystal structure and a spherical morphology (3). The multilayer coating further incorporates high-dimensional particles with a substantially spherical or quasi-spherical morphology (6), or a substantially laminar or quasi-laminar morphology (7).

### DETAILED DESCRIPTION OF THE INVENTION

The present invention provides a single-layer or multilayer sol-gel coating formed on a vitrified ceramic enamel base substrate. The base substrate whereon the sol-gel coating will be formed constitutes the surface finish of products obtained by means of a high-temperature firing process (>900° C., and it may even exceed 1250° C.). The surface of the vitrified ceramic enamel piece obtained by firing at said temperatures has a vitreous character, is continuous and has no open porosity.

Therefore, according to the present invention, the single-layer or multilayer sale-gel coating is obtained on a vitrified ceramic enamel substrate that presents a vitreous, continuous surface without open porosity. Optionally, the substrate surface may have embedded inorganic crystals such as, for example, zirconium crystals, ZrSiO₄, with an equivalent size ranging between 500 and 4000 nm, as is generally the case in sanitary porcelain. Part of these crystals may be partially localised and protruding from the substrate surface, in which case they typically present an elevation value of 300-500 nm with respect to the surface limit.

A first aspect of the invention provides a process for obtaining a single-layer sol-gel coating on a vitrified ceramic enamel substrate, which comprises the following steps:

a) preparation of a solution of a silicon alkoxide in a polar solvent; preferably, said solvent is a primary alcohol or a mixture of different primary alcohols;

b) preparation of a dispersion in a liquid medium selected from water or a polar solvent, which comprises low-dimensional particles selected from particles with a spherical, fibrillar or laminar morphology, or combinations thereof, wherein said particles have a laminar crystal structure and at least one of the dimensions, thickness or diameter, of said particles is less than 400 nm, preferably less than 100 nm;

c) addition of the dispersion obtained in step b) to the solution obtained in step a), drop by drop if it has been prepared in water, and directly, followed by the drop-by-drop addition of water, if it has been prepared in a polar solvent;

d) drop-by-drop addition of a catalyst to the solution obtained following step c), in order to accelerate the reaction of the sol-gel process;

e) deposition on said substrate of the suspension obtained, to a maximum thickness of 800 nm; and

f) densification of the coated substrate at a temperature equal to or greater than 500° C.

Preferably, in the event that, in step b), the dispersion of particles is prepared in water, in step c) this dispersion must be added drop by drop to the solution prepared in step a). In the event that, in step b), the dispersion of particles is prepared in a polar solvent, in step c) this dispersion is added to the solution prepared in step a) and, subsequently, water must be added drop by drop to the solution-dispersion combination. The solution obtained following addition of the dispersion to the solution contains particles at a concentration of up to 50% by weight of the equivalent in inorganic compounds following consolidation of the sol-gel.

Thus, the process according to the present invention makes it possible to overcome the problems arising from the formation of cracks during the drying or densification steps of the sol-gel for coatings with a thickness >400 nm.

The authors of the present invention have found that the addition of nanoparticles with a laminar crystal structure to a sol-gel coating substantially minimises the influence of the thickness on the mechanical and chemical resistance of the coating.

Advantageously, the present invention allows for the volume contraction forces that are produced along the coating surface during the drying or densification steps not to exceed those of the siloxane bonds created with the substrate and, consequently, this prevents the problems arising from the formation of cracks and coating detachments in single-layer coatings with thicknesses greater than 400 nm.

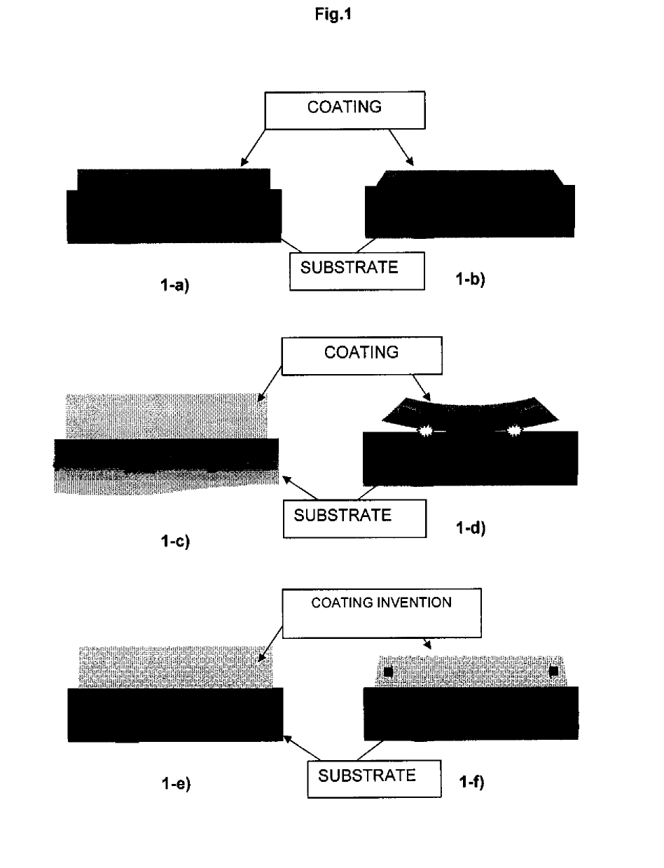

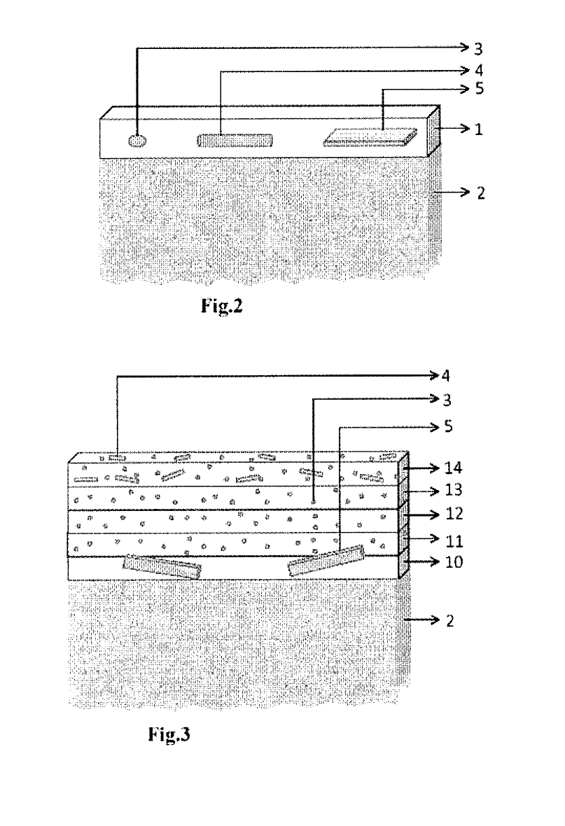

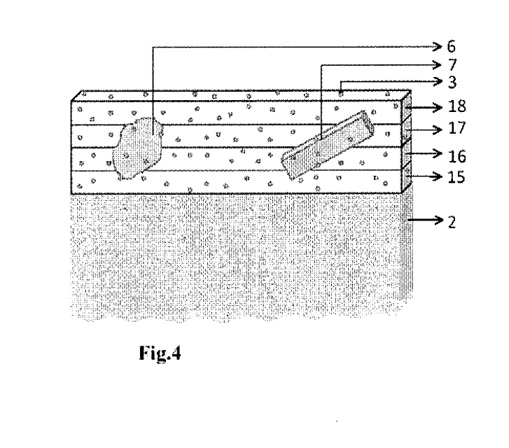

Surprisingly, the addition of nanoparticles with a laminar crystal structure to obtain the sol-gel coating prevents the breakage of the siloxane bonds that arises from the differences in contraction caused by evaporation of the solvent and the water along the thickness of the coating layer, as observed in attached FIG. 1, in particular in 1-e) and 1-f).

According to the second aspect of the present invention, a process is provided for obtaining a multilayer sol-gel coating on a vitrified ceramic enamel substrate, which comprises obtaining a multilayer structure, with layers having a different composition and/or morphology, wherein at least one of said layers fulfils the requirement of the first aspect of the invention. In said multilayer structure, each layer may have a thickness of up to 800 nm.

In obtaining the multilayer structure, the same process described in regards to the first aspect of the invention will be followed, but, in this case, the preparation of the dispersion of step b) may include the addition of high-dimensional particles, as described below:

b) preparation of a dispersion in a liquid medium selected from water or a polar solvent, which comprises:
low-dimensional particles selected from particles with a spherical, fibrillar or laminar morphology, or combinations thereof, wherein said particles have a laminar crystal structure and at least one of the dimensions, thickness or diameter, of said particles is less than 400 nm, preferably less than 100 nm;
and, optionally, at least one type of high-dimensional particles selected from particles with a spherical or laminar morphology, wherein at least the smallest dimension, thickness, diameter or length, ranges between 400 nm and 8000 nm.

The rest of the steps proceed in the same manner until the thermal treatment of the sol-gel coating, which is followed as described below:

f) thermal treatment of the coated substrate with the suspension obtained in step c) at a temperature equal to or lower than 550° C., preferably equal to or lower than 500° C.; and

g) repetition of steps a)-f) until a multilayer sol-gel coating is obtained, provided that the thermal treatment in the last layer, or outer layer, is performed at a temperature equal to or greater than the temperature used in step f).

Thus, the present invention provides a process for obtaining a functional multilayer coating on vitrified ceramic enamels; in particular, sanitary porcelain enamels, sanitary stoneware, ceramic floortiles and tiles, and steel and cast iron bathtub enamels. The coating is obtained by means of the sol-gel process and comprises inorganic particles that reinforce said coating and protect it against wear by abrasion.

The second aspect of the invention relates to the combination of different particles that have at least one dimension, thickness or diameter, of less than 400 nm, even more preferably, less than 100 nm, which allows for the incorporation thereof into a multilayer structure with a thickness of up to 800 nm in each layer, preferably up to 600 nm, and with up to 10 layers, preferably up to 6 layers. The layers are deposited on an enamelled, ceramic, vitrified surface or substrate, typical of sanitary porcelain, sanitary stoneware, ceramic floortiles and tiles, or steel and cast iron bathtub enamels, leading to a multilayer coating that presents different functional characteristics.

Optionally, according to the present invention, a prior step is performed to clean the vitrified ceramic enamel substrate. The cleaning step involves washing with soapy water, rinsing with water, followed by washing with acetone, drying and, once again, washing with an alcohol such as, for example, ethanol, and final drying. The cleaning of carbonaceous residues and, in particular, potential organic residues favours the subsequent adhesion of the sol-gel layer. This cleaning step is not limiting and, therefore, different cleaning means may be used, like chemical means, such as, for example, using different surfactants in the washing water; mechanical means, such as, for example, pressure and/or temperature water washing machines; or physical means, such as, for example, washing by means of ultrasound or oxygen plasma chambers. Therefore, the optional previous step designed to clean the substrate to be coated comprises cleaning by chemical, mechanical or physical means, or a combination thereof.

Once the substrate surface to be coated has been cleaned, the previously prepared sol-gel layer will be deposited, and so on, until a multilayer structure is obtained which preferably comprises at least 3 layers, more preferably, 6 layers, and a maximum of 10 layers.

The sol-gel is obtained by the hydrolysis and condensation of a formulation that comprises: at least one silicon alkoxide as a precursor; at least one polar solvent, such as an alcohol or a mixture of alcohols; at least metal oxide particles, optionally, metal or semiconductor or carbon-based particles; water; a catalyst and, optionally, a dispersant agent, a levelling agent and a drying control agent, where said additional components may be of an organic or inorganic type.

In the present invention, the term “silicon alkoxide”, also known as “alkoxysilane”, is understood to mean a chemical compound derived from silicon which is composed of a silicon atom bound to at least one organic group through an oxygen atom (Si—OR). Typical examples are tetraethyl orthosilicate (TEOS), methyltriethoxysilane (MTES), methyltrimethoxysilane, 3-glycidoxypropyltrimethoxysilane, vinyltriethoxysilane, etc.

In the present invention, if the type of particles, low- or high-dimensional, is not specified, the term “particles” refers to both low-dimensional particles and high-dimensional particles.

The selection of the particles to be incorporated in obtaining each layer of the coating is conditioned by the dimensions thereof. Thus, when using low-dimensional particles, one of their dimensions, thickness or diameter, must be less than 400 nm and, especially preferred, less than 100 nm. These low-dimensional particles are characterised in that they have different morphologies, such as: laminar or fibrillar type, in which case the smallest dimension to be considered corresponds to the thickness or the diameter, respectively; or spherical or quasi-spherical type, in which case the smallest dimension corresponds to the diameter; and they are also characterised in that they present a laminar crystal structure.

The low-dimensional particles may be of an oxidic nature, formed by a metal cation or several cations, to give a double oxide or a mixture of simple oxides. Moreover, the low-dimensional particles may correspond to an arrangement or material composed of different elements, such as, for example, metallic nanoparticles supported on an oxide particle, provided that at least one of the dimensions thereof fulfils the criterion described above. The origin of the low-dimensional particles may be mineral, as in clay particles, or they may be synthesised particles, such as, for example, α-Al₂O₃ nanoparticles, or supported synthesised nanoparticles such as, for example, titanium oxide nanoparticles supported on laminar mica particles. The nature of said particles may also be metallic, or carbon-based, such as, for example, silver nanoparticles or carbon or graphite nanofibres, albeit not limited to these examples.

One of the most critical aspects to be resolved involves the agglomeration of the low-dimensional particles and, if applicable, the nanoparticles. In order to overcome this limitation, the present invention includes a step b) designed to prepare a dispersion of the particles in a liquid medium such as water. Optionally, the dispersion may contain a solvent, a dispersant agent, a levelling agent, a drying control agent for the sol-gel layer, or a combination thereof. If a solvent is used in step b), it is preferable to use the same solvent in step a) and step b) of the process.

For the preparation of the dispersion in step b), the concentration of low-dimensional particles with a laminar morphology may be up to 60% by weight of the equivalent in inorganic compounds following consolidation of the sol-gel. One example of low-dimensional particles with a laminar morphology may be approximately 15 μm in length and approximately 300 nm in thickness, such as, for example, mica particles supporting titanium nanoparticles or other inorganic oxides such as, for example, Iriodin®.

The concentration of low-dimensional particles with a fibrillar morphology may be up to 25% by weight of the equivalent in inorganic compounds following consolidation of the sol-gel. One example of low-dimensional particles with a fibrillar morphology may be approximately 60 nm in diameter, with lengths greater than approximately 2000 nm, such as, for example, carbon nanofibres.

The concentration of low-dimensional particles with a spherical morphology may be up to 45% by weight of the equivalent in inorganic compounds following consolidation of the sale-gel. One example of low-dimensional particles with a spherical morphology may be approximately 70 nm in diameter, such as, for example, alumina nanoparticles.

On the other hand, the concentration of high-dimensional particles used in a multilayer coating may be up to 60% by weight of the equivalent in inorganic compounds following consolidation of the sale-gel.

The suspension obtained is dispersed using high-speed shearing processes, such as: Cowles type dispersion, dispersion using rotor-stator systems or attrition grinding systems with micro-balls, albeit not limited to these processes. The means used must be effective in favouring the low-dimensional particles to be dispersed in the medium and, in the event that agglomerates exist, these must be within the upper size limits required for the low-dimensional particles described above. The concentration of low-dimensional particles in the medium must be sufficient for said concentration to be close to the limit whereat the viscosity of the suspension drastically increases. Thus, the collision of the particles themselves makes it possible to effectively reduce the agglomeration state. For example, for 70-nm α-Al₂O₃ nanoparticles, it is acceptable for the maximum size of the agglomerate to be within the limits set by the thickness of a final sol-gel layer (800 nm), thereby assimilating the agglomerate to a particle with at least one dimension within those specified in the present invention.

Subsequently, the suspension obtained in step c) is diluted to facilitate adequate application of the sol-gel. The concentration of the particles or combination thereof will be such that it corresponds to up to 50% by weight of dry residue once the solvent and the water used have been eliminated. During step b), designed to prepare the dispersion, dispersant agents such as, for example, polyacrylic acid may be used to favour de-agglomeration of the particles. Likewise, during step c), of addition of the dispersion to the solution prepared in step a), catalysts such as, for example, hydrochloric acid may be added, which act synergically in the dispersion process, producing an increase in the zeta potential value of the particles by adjusting the pH value of the suspension. Preferably, the suspension obtained in step c) is adjusted to a pH value ranging between 2 and 5, preferably between 2 and 4.

In the present invention, the term “dispersant agent” is understood to mean a surfactant additive, which is added to a suspension in order to promote the maximum uniform separation of very small solid particles, often of a colloidal size. One example are polyacrylates such as polyacrylic acid. For more information, see 2004, 76, 1995, IUPAC, “Compendium of Chemical Terminology 2007”.

In the present invention, the term “catalyst” is understood to mean an additive that may accelerate or delay the hydrolysis and polycondensation reactions. One example may be hydrochloric acid.

In the present invention, the term “drying control agent” (or Drying Control Chemical Additive, DCCA) is understood to mean an additive with a very low vapour pressure and a high boiling temperature, e.g. dimethylformamide, propanetriol, acetonitrile. For more information, see “Sol-Gel technology for thin films, fibers, preforms, electronics, and specialty shapes”, Lisa C. Klein William Andrew, 1988.

In the present invention, the term “levelling agent” is understood to mean a surfactant additive, the mission whereof is to improve levelling through the reduction of the surface tension in the coating. Silicone oils (polysiloxanes) are primarily used, but fluorinated compounds and acrylates are also used. The operation of levelling agents is based on the fact that, due to their very low surface tension, they are rejected by the coating and the substrate. “Levelling” is understood to mean the capacity of a liquid coating to be laid out such that the structure of the coating surface, produced by the application process, may be distributed or spread as best as possible. Therefore, the result of good levelling is a smooth surface. The levelling is dependent on good wetting of the substrate, as well as the viscosity of the coating material and the surface tension of the components. One example is a polyether-modified polydimethylsiloxane. For more information on levelling agents or levelling, see “Coatings from A to Z: A Concise Compilation of Technical Terms Paolo Nanetti Vincentz Network”, GmbH & Co KG, 2006.

The precursor sol-gel solution thus prepared, which contains the low-dimensional particles with a laminar crystal structure, is deposited on the substrate according to step d) by immersion, casting, atomisation, spraying, or a similar method that allows for an adequate distribution of the layer. Preferably, the deposition of the sol-gel solution is performed by spray atomisation and, even more preferably, the solution is deposited by means of airless spray application, especially in surfaces with a large size and/or complex shapes, such as concave and/or convex shapes.

The preferred thickness of a single layer obtained is between 400 and 800 nm, preferably between 400 and 600 nm. This thickness is variable as a function of the viscosity of the sol, which is dependent, amongst other factors, on the existing concentration of low-dimensional particles.

Once the sol-gel layer has been deposited, the suspension of low-dimensional particles allows for said particles to remain inside the sol-gel layer. This process is restricted when the smaller dimensions of the low-dimensional particles or the agglomerates thereof are close to the thickness of the sol-gel layer. Said restriction is resolved by forming a multilayer structure through the deposition of successive layers that exclusively contain dispersed low-dimensional particles different from the above, wherein the size of at least one of the dimensions is less than the thickness of a sale-gel layer.

The formation of a multilayer structure favours homogeneity of the coating and reduces the presence of defects produced by irregularities in the deposition. Thus, a multilayer coating containing three layers, preferably containing 6 layers, obtained according to the second aspect of the present invention behaves like a continuous coating, without any cracks or defects, once it is consolidated. The outer layers are formed by a precursor wherein the low-dimensional particles are at a low concentration and the maximum dimensions thereof are preferably smaller than the wavelength of visible light. These outer layers do not produce light absorption and maintain the gloss and reflectance characteristic of sanitary porcelain enamel. The incorporation of low-dimensional particles capable of reflecting and refracting light, with a size similar to that of the wavelength of visible light, produces innovative aesthetic effects, as in the case of coatings based on laminar mica particles supporting nanoparticles made of titanium or other inorganic oxides such as, for example, Iriodin®, albeit not restricted to this commercial reference, which are not compatible with the standard processes for obtaining a sanitary porcelain due to the high temperatures (>1000° C.) whereto the sanitary porcelain is subjected. The presence of outer layers facilitates that said low-dimensional particles are completely incorporated inside the multilayer coating.

An advantageous aspect is the incorporation of high-dimensional particles the smallest dimension whereof is less than 2000 nm but not within the specified 800-nm limit. In this case, the successive deposition of 3 layers, preferably 5 layers, produces a coating wherein the high-dimensional particles are inside the multilayer structure. This coating is characterised in that it lacks specular gloss, due to the fact that high-dimensional particles disperse light.

Thus, for example, glass microparticles containing silver nanoparticles may be incorporated, such as the product lonpure®, albeit not limited to said material or said product, which have an average particle size of 2-4 μm. The deposition of a first sol-gel layer containing up to 20% of said particles by weight of the equivalent in inorganic compounds following consolidation of the sol-gel makes it possible to deposit said microparticles on the sanitary substrate. The successive deposition of sol-gel layers containing, for example, 1% of dispersed α-Al₂O₃ nanoparticles 70 nm in diameter allows for the anchoring of the microparticles, i.e. the high-dimensional particles. The particles of the product lonpure® used in this embodiment are characterised in that they have a bactericidal effect and, moreover, the resulting coating acquires this functionality because said particles are anchored in the coating, since the particles are dispersed in the coating, and, preferably, said particles are within the limit of the last layer, or outer layer. Therefore, it is possible for said high-dimensional particles to be perfectly anchored in the multilayer coating and, at the same time, in contact with the maximum thickness limit of the coating, so as to better release their bactericidal effect to the exterior.

The consolidation of the different layers in a multilayer coating requires a thermal treatment (thermal densification), following the deposition of each layer, at a temperature equal to or lower than the treatment temperature of the last layer, or outer layer. Once each of the layers that form the coating have been thermally treated, the final thermal treatment of the last layer, or outer layer, must take place at a temperature equal to or greater than that used in the intermediate treatments, in order to guarantee a monolithic coating with adequate adhesion between the layers.

Thus, for example, a multilayer sol-gel coating may be obtained by forming a first layer with 20% by weight of the equivalent in inorganic compounds of Iriodin® after consolidation of the sol-gel, followed by a thermal treatment at 500° C. for 2 hours; a second, a third and a fourth layer with 1% by weight of 70 nm alumina nanoparticles followed by a thermal treatment at 500° C. for 2 hours after the deposition of each one, and, finally, a fifth layer containing 1% by weight of 70-nm alumina nanoparticles and 0.5% by weight of carbon nanofibres. Said multilayer structure, i.e. after the incorporation of the fifth layer, is treated at least 500° C. for 2 hours in order to obtain a multilayer structure characterised in that it is a coating composed of layers with different concentrations of low-dimensional particles characterised by a laminar crystal structure. Said coating is characterised by a high gloss, a colour and the presence of characteristic metallic reflections conferred by the Iriodin® particles, and presents optimal surface properties of hardness, abrasion resistance and chemical resistance.

The multilayer structure that forms the coating obtained according to the second aspect of the invention is characterised in that it provides a continuous particles net wherein particles are dispersed which have an adequate response to abrasion since said particles act as abrasion-resistant elements. The coating is also characterised in that it has a surface roughness of less than 500 nm, preferably less than 300 nm, which produces a high gloss.

Moreover, the coating obtained according to the present invention supports a normalised cleaning assay of over 7000 runs. As compared to other existing coatings for sanitary porcelain, primarily organic or hybrid ones, this response is clearly superior in performance, which makes it useful to be used in sanitary porcelains. The thermal treatment temperature makes it possible to maintain the functionality of the low-dimensional particles used without these being degraded.

Advantageously, the incorporation of a sol-gel layer containing, for example, 1% by weight of carbon nanofibres makes it possible to obtain the exceptional wear resistance properties once the coating is consolidated, i.e. once the sol-gel layer has been thermally treated.

In the particular case of high-dimensional particles, the aspects described above are applicable, except that the coating does not have the characteristic specular gloss due to the diffuse reflection that said particles produce on light.

Thus, the invention solves the problem of incorporating functional particles into sanitary enamels. The high-temperature consolidation process in a vitreous matrix such as that of sanitary enamels thermally and chemically degrades functional microparticles. The present invention allows for the incorporation and consolidation of a combination of particles in the form of low-dimensional particles, such as those described above, with a laminar crystal structure. Part of the solution to the problem arises from the use of dispersed suspensions of low-dimensional particles for the incorporation thereof in the sol-gel layers.

Said combination of different low-dimensional particles has also been developed combined with high-dimensional particles, which contribute functions to the sanitary enamel. The functionalities to be incorporated in the sol-gel coating according to the present invention include the following: specular gloss; wear resistance; chemical resistance; stain resistance; metallic reflections; irridescence; phosphorescence; electrical conductivity; magnetic order; thermochromism; bactericidal effect. Since the functional properties are developed on the basis of the properties of the low- or high-dimensional particles incorporated in the structure of the sol-gel layers, the functional properties are not limited to those described above and may be expanded to include new functionalities.

Below, we include a table with the type of particles to be used according to the desired functionality, as an example which does not limit the scope of the invention.

| FUNCTIONALITY | PARTICLES |
|---|---|
| Modified light spectrum | Particles with a laminar crystal structure |
| reflectance | obtained from bismuth oxychloride or |
| | sheets of silicon dioxide or mica or |
| | borosilicates or aluminum oxide, synthetic |
| | or natural, which may or may not be coated |
| | to different degrees of thickness with metal |
| | oxides such as titanium dioxide and/or iron |
| | oxide |
| Fluorescence | Fluorescent pigments and colouring agents |
| Phosphorescence | Phosphorescent pigments |
| pH sensor | pH indicators |
| Electrical conductivity | Carbon nanofibres |
| Improved abrasion | Carbon nanofibres |
| resistance | |
| Improved resistance against | Alumina or silica nanoparticles |
| abrasion and chemical | |
| agents | |
| Thixotropic, increased | Silica nanoparticles |
| coating thickness | |
| Antibacterial | Nanoparticles containing silver |
| Thermochromism | Thermochromic pigments |
| Open porosity | Surfactant |

Moreover, the process according to the first and second aspects of the present invention makes it possible to solve the problems of obtaining a sol-gel coating on a sanitary porcelain substrate with a large size and/or complex shapes, such as concave and convex shapes. Preferably, once the dispersion and the suspension containing it have been prepared, the sol-gel is applied using an air-assisted airless equipment.

Advantageously, the deposition of the sol-gel with an air-assisted airless equipment makes it possible to: reduce the application time; reduce the consumption of application solution; have less rebound currents than in a normal aerographic application, especially on concave surfaces; save solvent, due to deposition of the sol-gel with minimal evaporation of the solvent; obtain a better stretch (surface uniformity), due to better wettability; improve penetration of the coating in the irregularities of the substrate surface; improve adhesion to the substrate; improve control of the desired thickness; reduce the number of surface defects; obtain greater covering power as compared to a normal aerographic application; and also regulate the drying of the atomisation, thereby preventing potential fall-outs in vertical walls, since air-assisted airless spraying systems are used.

### EMBODIMENTS OF THE INVENTION

### Example 1

### Single-Layer

Obtainment of a sanitary piece coated with a high-thickness single-layer sol-gel with a metallic appearance, capable of modifying the wavelength of the reflected light by means of constructive and destructive interferences by incorporating low-dimensional particles. In order to perform this process, the following components are used:
226 ml Ethanol (C₂H₆O)
107.07 ml Tetraethyl orthosilicate (TEOS) (SiC₈H₂₀O₄)
34.02 ml de-ionised water (H₂O)
20.00 g Iriodin® Gold (low-dimensional particles with a laminar crystal structure)
0.20 g of carbon nanofibres
0.4 ml Hydrochloric acid (HCl)
0.08 g of polyacrylic acid (dispersant agent)
0.24 g of polyether-modified polydimethylsiloxane (film-forming agent)

Initially, the precursor (TEOS) is incorporated into the alcohol under stirring. The golden Iriodin® have been previously dispersed in the water, jointly with the carbon nanofibres, by means of high-shear stirring, using 0.08 g of Dolapix 64 as a dispersant agent, for 10 minutes. This mixture is added to the above drop by drop and, finally, the catalyst (HCl) is incorporated, also drop by drop, which produces an increase in the sol temperature that indicates that hydrolysis is taking place. The mixture is continuously stirred until the temperature thereof decreases and, finally, 0.24 g of Byk-UV 3510, which is the film-forming agent, are slowly added. The reactor is kept under stirring for 15 more minutes.

Once the sol has been hydrolysed, it is deposited on the substrate by means of air-assisted airless spraying, and subjected to a thermal treatment at 500° C. for 2 hours, at a heating rate of 1° C./min, for densification of the sol-gel layer.

In this manner, a high-thickness single-layer sale-gel coating is obtained, which reaches 1.5 mg/cm² in terms of the weight of dry matter, presents a metallic appearance due to the modified reflection of incident light, and has a wavelength that is a function of the chemical composition and the thickness of the layers of Iriodin® incorporated. Said coating exhibits excellent properties against wear and chemical resistance.

### Example 2

Obtainment of a multilayer coating with metallic reflections using the sol-gel technique, by incorporating low-dimensional particles in different layers. In order to perform this process, the following components are used:
82 ml Ethanol (C₂H₆O)
19.45 ml Tetraethyl orthosilicate (TEOS) (SiC₈H₂₀O₄)
6.18 ml de-ionised water (H₂O)
1.53 g Iriodin® Gold (low-dimensional particles with a laminar crystal structure)
0.053 g aluminum oxide (Al₂O₃) (Nanoparticles)
0.053 g Carbon Nanofibres (CNF)
0.1 ml Hydrochloric acid (HCl)
0.2 g of polyacrylic acid (dispersant agent)

Initially, the precursor (TEOS) is incorporated into the alcohol under stirring. The Au lriodin® has been previously dispersed in the water by means of high-shear stirring, using 0.4% by weight of Dolapix 64 as a dispersant agent, for 10 minutes. This mixture is added to the above drop by drop and, finally, the catalyst (HCl) is incorporated, also drop by drop, which produces an increase in the sol temperature that indicates that hydrolysis is taking place. The mixture is continuously stirred for 60 minutes.

Once the sol has been hydrolysed, it is deposited on the substrate by immersion-extraction and subjected to a thermal treatment at 500° C. for 2 hours, with a heating rate of 1° C./min, for densification of the sol-gel layer.

Subsequently, another sol is prepared in the same manner as in the preceding case, but, instead of adding the Iriodin®, the alumina nanoparticles are dispersed in the water following a process similar to that described above, and added to the mixture. Once the sol has been prepared, it is deposited on the previously thermally treated samples, and is once again treated at 500° C. for 2 hours. This process is repeated two more times.

Finally, another sol is prepared where, in addition to the alumina particles, the Carbon nanofibres are added to the water, and they are dispersed and incorporated into the sol. It is deposited on the previously treated layers and sintered with a treatment at 500° C. for 2 hours.

As a result, a glossy multilayer coating is obtained which incorporates the coloured metallic reflections of the Iriodin®, and wherein the upper layers make it possible to obtain excellent properties against wear and chemical resistance.

Example 2 was repeated but, in this case, once the sol was hydrolysed, it was deposited on the substrate by spraying with an airless system. The rest of the process followed Example 2. It is worth noting that, in this case, superior adhesion results were obtained, as well as a lower number of surface defects.

### Example 3

Obtainment of a phosphorescent multilayer coating following a process similar to that described in Example 1, wherein, instead of adding the Iriodin® in the suspension of the first sol-gel layer, cuboid-type low-dimensional particles of Eu²⁺-doped SrAl₂O₄ are incorporated. Said particles present a particle size ranging between 200 and 400 nm. The rest of the process remains the same.

As a result, a glossy multilayer coating is obtained which incorporates the phosphorescence function thanks to the Eu²⁺-doped SrAl₂O₄ compound. The upper layers make it possible to obtain excellent properties against wear and chemical resistance.

Example 3 was repeated but, in this case, the number of intermediate layers containing alumina nanoparticles was limited to a single layer. It is worth noting that, as a result, a coating with a greater intensity of the phosphorescent response was obtained.

### Example 4

Obtainment of a conductive multilayer coating following a process similar to that described in Example 1, wherein, instead of adding the Iriodin® in the suspension of the first sol-gel layer, low-dimensional particles, based on a combination of carbon nanoparticles, 2-20 nm in particle size, and carbon nanofibres, 40-60 nm in diameter and 5-200 82 m in length, are incorporated at a concentration of 40% by weight of the equivalent in inorganic compounds following consolidation of the sol-gel. The nanoparticles/nanofibres ratio is 9:1. The rest of the process remains the same.

As a result, a glossy, black-colour multilayer coating is obtained. The connectivity of the carbon nanoparticles/nanofibres of the first sol-gel layer lead to a resistivity of 10 kΩ·cm⁻¹. Application of a 90-volt potential difference makes it possible to heat the coating from room temperature to a temperature of 32° C. The upper layers make it possible to obtain excellent properties against wear and chemical resistance, and, moreover, act as an electrical insulator from the first conductive layer.

### Example 5

Obtainment of a bactericidal multilayer coating following a process similar to that described in Example 1, wherein, instead of adding the Iriodin® in the suspension of the first sol-gel layer, lonpure® particles 2-4 μm in size are incorporated. Said particles have a larger particle size than that designated for low-dimensional particles. The rest of the process remains the same.

As a result, a glossless multilayer coating is obtained which incorporates the bactericidal function thanks to the compound lonpure®, vitreous particles containing Ag⁺ nanoparticles. The upper layers make it possible to obtain excellent properties against wear and chemical resistance.

1. A process for obtaining a sol-gel coating on a substrate, characterised in that said substrate is a vitrified ceramic enamel substrate and the obtainment of one layer comprises the following steps:
a) preparation of a silicon alkoxide solution in a polar solvent;
b) preparation of a dispersion in a liquid medium selected from water or a polar solvent, which comprises low-dimensional particles selected from particles with a spherical, fibrillar or laminar morphology, or combinations thereof, wherein said particles have a laminar crystal structure and wherein at least one of the dimensions, thickness or diameter, of said particles is less than 400 nm;
c) addition of the dispersion obtained in step b) to the solution obtained in step a), drop by drop if it has been prepared in water, and directly, followed by the drop-by-drop addition of water, if it has been prepared in a polar solvent;
d) drop-by-drop addition of a catalyst to the solution obtained following step c), in order to accelerate the reaction of the sol-gel process;
e) deposition of the suspension obtained on said vitrified ceramic enamel substrate to a maximum thickness of 800 nm; and
f) thermal treatment or densification of the substrate at a temperature equal to or greater than 500° C.

2. The process according to claim 1, wherein, in order to obtain successive layers, the following steps are modified:
b) preparation of a dispersion in a liquid medium selected from water or a polar which comprises:
low-dimensional particles selected from particles with a spherical, fibrillar or laminar morphology, or combinations thereof, wherein said particles have a laminar crystal structure and wherein at least one of the dimensions, thickness or diameter, of said particles is less than 400 nm; and
optionally, at least one type of high-dimensional particles selected from particles with a spherical or laminar morphology, and wherein at least the smallest dimension, thickness, diameter or length, ranges between 400 nm and 8000 nm;
f) thermal treatment or densification of the substrate at a temperature equal to or lower than 550° C.; and
The following step is added:
g) repetition of steps a)-f) until a multilayer sol-gel coating is obtained, provided that the thermal treatment in the last layer, or outer layer, is performed at a temperature equal to or greater than the temperature used in step f).

3. The process according to claim 1, wherein step b) further comprises at least one of the following components: dispersant agent, levelling agent and drying control agent.

4. The process according to claim 1, wherein, in step a), said silicon alkoxide is selected from tetraethyl orthosilicate (TEOS), methyltrimethoxysilane, 3-glycidoxypropyltrimethoxysilane, vinyltriethoxysilane or mixtures thereof.

5. The process according to claim 1, wherein the deposition of step e) is performed with an air-assisted airless equipment.

6. The process according to claim 2, wherein said multilayer sol-gel coating comprises at least 3 layers and a maximum of 10 layers.

7. The process according to claim 2, wherein said multilayer sol-gel coating comprises low-dimensional particles and high-dimensional particles.

8. The process according to claim 1, wherein said particles are of an oxidic nature, formed by a metal cation or several cations, to produce a compound or a mixture, or carbon-based.

9. The process according to claim 1, wherein said particles are selected from metallic nanoparticles supported on an oxide particle, silver nanoparticles, carbon nanofibres, phyllosilicate particles or a particulate organic material.

10. The process according to claim 1, wherein the sol-gel coating is performed on a substrate of vitrified ceramic sanitary porcelain enamel, sanitary stoneware, ceramic floortiles, ceramic tiles and enamelled steel and cast iron bathtubs.

11. A multilayer sol-gel coating obtained according to claim 2, to be used on a vitrified ceramic enamel substrate.
